(19) United States
(12) Patent Application Publication
(10) Pub. No.: US 2003/0221366 A1
(43) Pub. Date: Dec. 4, 2003

(54) Portable plant container apparatus and method

(76) Inventors: Heather Weiner, Philadelphia, PA (US); Barent Roth, East Greenville, PA (US)

Correspondence Address: HAHN LOESER & PARKS, LLP, TWIN OAKS ESTATE, 1225 W. MARKET STREET, AKRON, OH, 44313, US

(21) Appl. No.: 10/354,369

(22) Filed: Jan. 30, 2003

Related U.S. Application Data
(60) Provisional application No. 60/353,010, filed on Jan. 30, 2002.

(51) Int. Cl. A01G 9/02

(52) U.S. Cl. 47/65.7; 47/66.7

(57) ABSTRACT

A portable plant container apparatus which can be worn by a user which allows constant monitoring of the growth of a plant. The portable plant container comprises a base and a cover secureable to a user which houses a living plant growing in a tissue culture medium. The apparatus is transparent allowing visual monitoring of the plant growth. The method of using the device provides for growing the plant in the device and then transplanting the plant into the soil of a larger container.

### TECHNICAL FIELD

This application claims the benefit of U.S. Provisional Patent Application Serial No. 60/353,010 filed Jan. 30, 2002, hereby incorporated by reference. The present invention relates to a method and apparatus for containing and displaying a plant. More specifically this invention relates to a method and portable apparatus containing a plant culture medium which permits seed germination and is worn by a person.

### BACKGROUND OF THE INVENTION

Seed germination and plant growth are fundamental biological processes of great scientific, educational and commercial interest. In particular, parents and teachers often wish to present plant growth to children and students, respectively, in a way that is both informative and dynamic, allowing observations of growth and development over time. However, the growth can typically only be viewed when visiting the location of the growth, typically in a pot or other container filled with soil. The growth of the shoot, i.e., the aerial portions of the plant (leaves, flowers and fruits), can be directly observed, the germinating seed, as well as the developing root system, which is often as extensive as that of the shoot system, are usually buried in the soil. Thus, seed germination and the developing root system are typically obscured.

Plants can be grown aseptically in tissue culture. The practice of growing plants and plant tissues on defined media in closed containers is well developed. Plant tissue culture is typically carried out either in a liquid or semi-solid culture medium or on a solid culture medium solidified with a gelling agent. In both liquid and solid culture, seed germination and the growth and development of shoots and roots can be directly observed because the culture medium is transparent.

Accordingly, there remains a need in the art for a method and portable apparatus which allows constant monitoring of plant growth while providing an aesthetically pleasing and interesting object that can be worn upon the user.

### SUMMARY OF THE INVENTION

The present invention provides a novel method and apparatus for a portable plant container which can be worn by a user which allows constant monitoring of the growth of a plant. These and other advantages are provided by a portable plant container comprising a base portion, a cover portion attached to the base portion and at least partially removeable from the base portion, a root chamber removeably secured adjacent the base portion, a culture material contained in the root chamber, a plant inserted at least partially in the culture material, a growth chamber formed between the root chamber and the cover portion, and means for attaching the base portion to a user. These and other advantages are also provided a method for growing a plant comprising the steps of a) providing a portable plant container comprising a base portion, a cover portion, and a band for attaching the base portion to a user; b) inserting a plant and a culture material into a root chamber; c) attaching the root chamber to the base portion; d) attaching the portable plant container to a user; d) observing the plant grow over a period of time.

These and other advantages of the invention will be apparent as disclosed in the detailed description of the drawings below.

### DESCRIPTION OF THE DRAWINGS

A better understanding of the present invention will be had when reference is made to the accompanying drawings, wherein:

FIG. 1 is a perspective view of a first embodiment of the portable plant container apparatus of the present invention with enclosed plant;

FIG. 2A is a plan view of the portable plant container apparatus of FIG. 1 and FIG. 2B is a side elevational view of the portable plant container apparatus of FIG. 1;

FIG. 3A is a plan view of the root chamber or culture medium container of the portable plant container apparatus of FIG. 1, FIG. 3B is a side elevational view of the root chamber of the portable plant container apparatus of FIG. 1, and FIG. 3C is an end view of the root chamber of the portable plant container apparatus of FIG. 1;

FIGS. 4A-4H is a series of figures showing the method for using the portable plant container apparatus of FIG. 1 and transplanting the growing plant to a larger container in accordance with another embodiment of the present invention;

FIG. 5 is a perspective view of another embodiment of the portable plant container;

FIGS. 6A-6G is a series of figures showing the method for using the portable plant container apparatus of FIG. 5 and transplanting the growing plant to a larger container in accordance with another embodiment of the present invention; and

FIG. 7 is an exploded perspective view of the growth chamber, root chamber, and germinated seed usable with the portable plant container of FIG. 5 in accordance with another embodiment of the present invention.

### DETAILED DESCRIPTION OF THE DRAWINGS

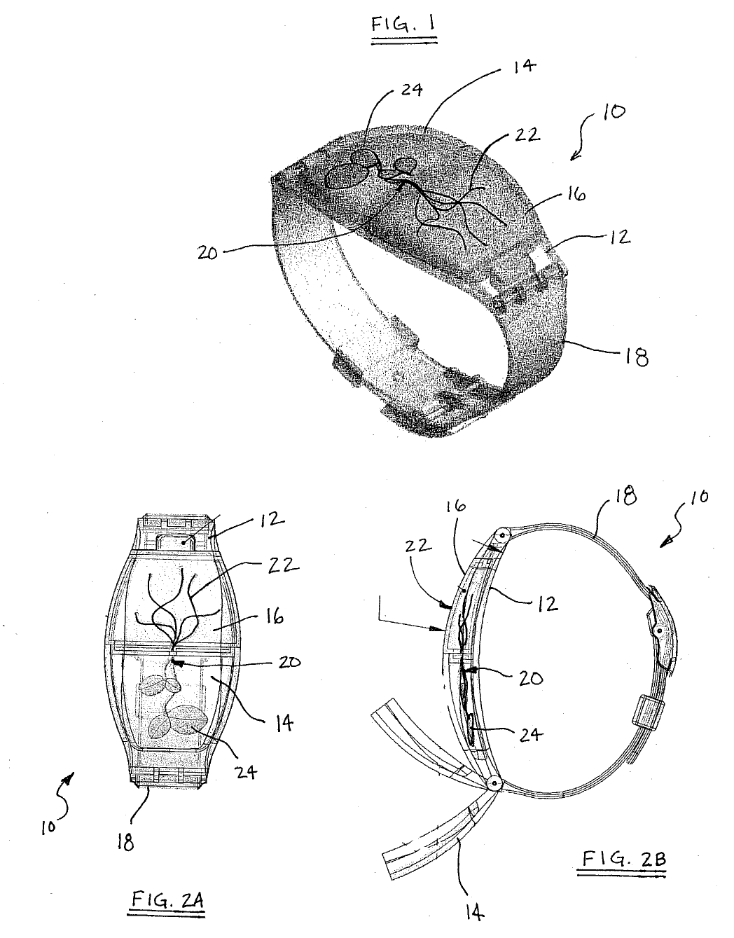

Referring to FIG. 1, a portable plant container apparatus 10 is shown which comprises a base portion 12, a cover portion 14, a root chamber 16 (also referred to as the culture medium container 16), and a means 18 for attaching the base portion 12 to a user, preferably at the wrist. A plant 20 is enclosed in the apparatus and comprises a root system 22 and an aerial portions 24. Although only one plant is shown, it is contemplated that multiple plants could be used with the present invention. The apparatus 10 is preferably made of a lightweight, material such as, but not limited to a polycarbonate material. This will minimize the weight of the container apparatus 10. The cover portion 14 and the culture medium container 16 are typically transparent such that the plant 20 can be viewed by the user while the plant 20 is growing. Cover 14 is preferably at least partially removable from base portion 12 such that access can be gained to the interior of container 10. The means 18 for attaching the base portion 12 to the user is shown as a wristband and buckle similar to that of a watch. Any known means to secure the apparatus 10 to the user is contemplated whether it be to the user's wrist, waist, pants, or other areas. Although shown as a wristband, the attachment means is also contemplated as a waist belt, necklace, pin, earring, or any other known jewelry attachment means. It is also contemplated that container 10 could be used attached to a pen, pocket watch, toys, or any other suitable application. Other types of bands or clips such as plastic, cloth, metallic, elastic, velcro, etc. could also be used and are contemplated herein.

Referring now to FIGS. 2A-2B, the portable plant container apparatus 10 is shown in various views. FIG. 2A show a view the typical user would observe when looking down at the portable plant container apparatus 10. The user can see the entire plant 20 as the plant roots 22 are adjacent the leaves and stems 24, instead of having the leaves and stems 24 blocking the view of the roots 22. This allows viewing of the entire plant growth. FIG. 2B shows a side elevational view of the portable plant container apparatus 10. The cover portion 14 is shown in an open position, a closed position, and an intermediate position. The cover portion 14 is hingedly attached to the base portion 12 on one end. The cover portion 14 covers a growth chamber 30 which is the area provided by the portable plant container apparatus 10 for the growth of the leaves and stems 24. When the cover portion 14 is open, access is provided to the leaves and stems 24. This allows the user to remove any dead portions or trim the plant 20 as needed.

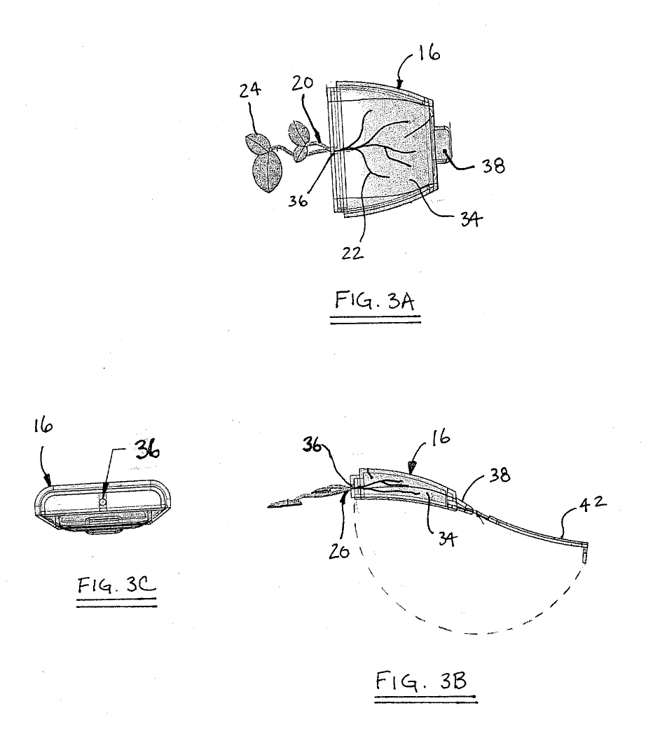

The culture medium container 16 is best shown in FIGS. 3A-3C. The culture medium container 16 can be made of a transparent plastic material, but is not intended to be limited as such. The culture medium container 16 forms a root chamber which is filled with a transparent culture material 34. Culture materials 34 or gelling agents are typically colorless. It is contemplated that different dyes can be used with culture material 34 and, therefore, be more attractive to children. The different colors may also provide an ability to color-code plant cultures for particular plants. The color tint will add to the aesthetic appearance of container 10 while at the same time, allowing higher visibility to roots 22 within transparent culture material 36. An aperture 36 is formed in a wall of the culture medium container 16 and allows the plant to grow from the root chamber 16 to the growth chamber 30. The culture medium container 16 comprises a container cover 42 which allows access to the interior of the culture medium container 16. This makes it easy to remove the culture material 34 and the grown plant 20 which is ready to be transplanted to a stationary location. The culture medium container 16 also has a tab 38 formed thereon which allows the culture medium container 16 to be removeably attached to the base 12.

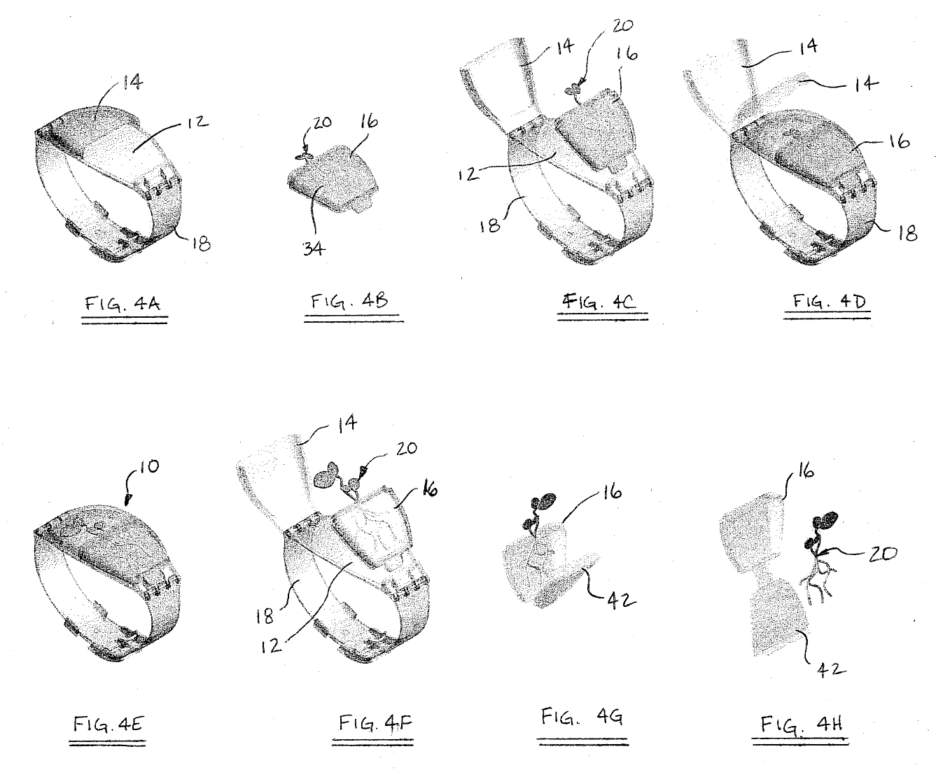

The method 40 of using apparatus 10 is shown in FIGS. 4A-4H. The user purchases the apparatus 10 which typically comes with the culture material container 16 provided separately. The culture material container 16 is filled with tissue culture 34 forming a root chamber for an included plant 20. The plant 20 may be in the form of a seed embedded in the tissue culture near aperture 36, or of a seedling having sprouts 20 protruding through aperture 36. The culture material container 16 is then attached to the base 12 by snapping the tab 38 into a receiver portion in base 12. The cover 14 is then moved downward and snaps into position over at least an end of the culture material container 16. The apparatus 10 is then worn by the user until the plant 20 is grown and ready to be transplanted. To remove the plant 20, the cover 14 is lifted and the culture material container 16 is removed from base 12. The culture material container door 42 is then opened to access the plant 20 and the plant 20 is then removed from the culture material container 16. The plant 20 is then ready to be planted in the soil. The apparatus 10 is reuseable and a new seed or seedling 20 can be grown in the device 10.

Another embodiment is shown in FIG. 5 showing a portable plant container 110 which comprises a cover portion 114 and optionally a base portion 112. A culture material 134, is provided in a plastic root chamber 116, is positioned within and secured to cover portion 114, or optionally secured to base portion 112. Culture material 134 is surrounded by a thin transparent plastic material forming root chamber 116. A plant 120 is shown within container 110 having roots 122 networked within culture material 134 in the root chamber 116 and shoots 124 extending into an open volume 130, or growth chamber, contained by cover portion 114. Container 110, or at least cover portion 114, is preferably made of a lightweight, transparent material such as, but not limited to a polycarbonate material. This will minimize the weight of the container and allow the contents to be viewed. Cover 114 is preferably removable from base portion 112 such that access can be gained to the interior of container 110. Cover 114 can also be configured with an integral magnifying lens 150 to enable the user to better view the plant 120. Container 10 comprises an attachment means 118 for attaching container 110 to a user as shown in the previous embodiment. Base portion 112 or cover portion 114 is contemplated to be either integral to attachment means 118 or separate from and detachably attachable to attachment means 118 by the use of hinge pins, clips, hooks, screws, Velcro or any other suitable attachment. This will allow the user to switch containers 110 on a specific attachment means 118, if desired.

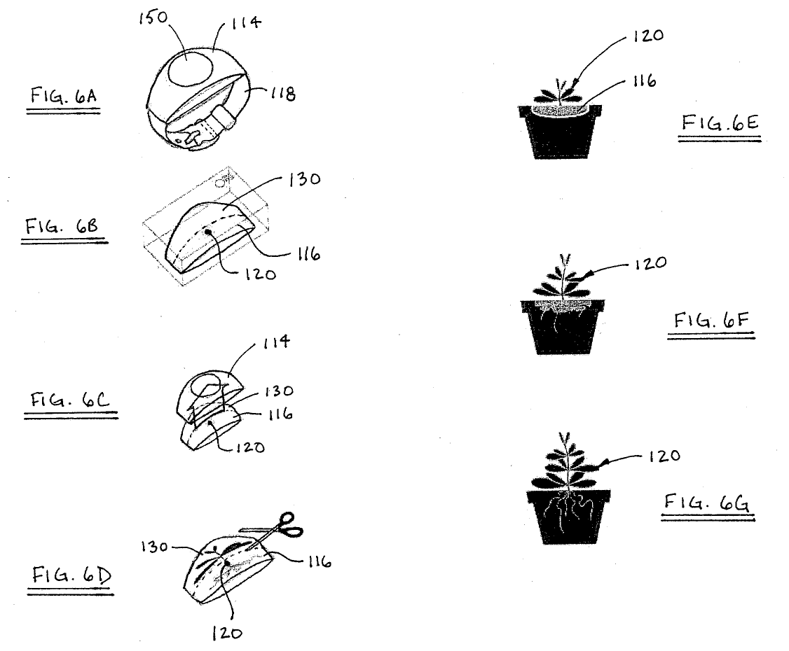

Referring to FIGS. 6A-6G, the method of using the apparatus 110 comprises the steps of providing a plant tissue medium container 110. At least one pre-germinated seed 120 is selected for use in container 10. Cover 112 of container 110 is removed or positioned to allow insertion of root chamber 116 containing culture material 136. The pre-germinated seed 120 is placed within culture material 136 through a hole cut in the thin transparent plastic material of the root chamber 116 covering culture material 136. The seed 120 is allowed to grow within container 110. Once plant 120 fills growing space 130, plant 120 and root chamber 116 are removed from container 110 and transplanted to soil. Once transplanted, root chamber 116 will biodegrade allowing roots to take hold in the soil as shown. If the root chamber 116 is not made of a biodegradable substance, the root chamber 116 is cut-away from the plant 120 prior to planting the plant 120 in soil. Container 110 is reusable by simply inserting another root chamber 116 enclosing culture material 136 and a seed 120.

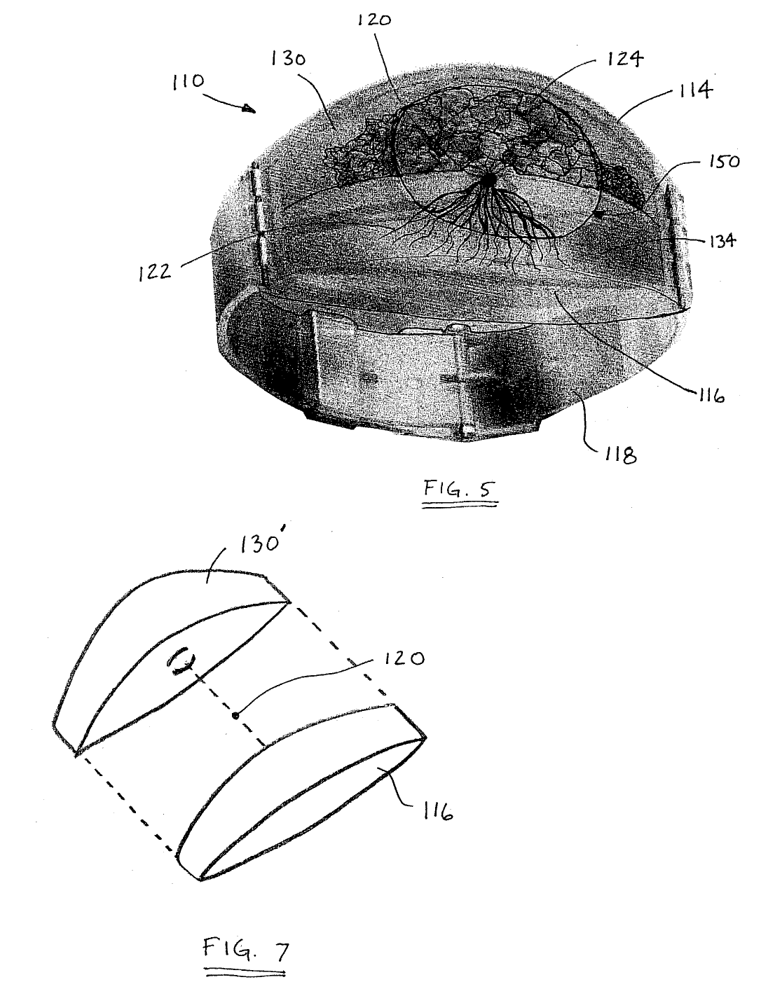

In an alternate embodiment, as shown in FIG. 7, culture material 136 is provided from the factory sealed in a root chamber 116 of plastic material and bonded to growth chamber 130′ also sealed in a plastic material. A germinated seed 120, or a pre-germinated seed which is subsequently germinated, is sealed between root chamber 116 and growth chamber 130′. The assembled components are then shipped to a user. The plant 120 grows from pre-germinated seed 120 into sealed root chamber 116 and growth chamber 130′. When ready for transplanting, growth chamber 130′ is cutaway. Sealed root chamber 116 is preferably biodegradable and can simply be placed into the soil.

As stated, a variety of materials, configurations, and applications can be employed in the practice of this invention. It is to be understood that such variations are intended to fall within the scope of the claimed invention and that the subject invention is not to be limited by the specific apparatus or method of operation described and/or depicted by the drawings nor is the invention to be limited by the specific materials and mechanical components identified and described herein. These have been designated merely to provide a demonstration of operability and the selection of mechanically equivalent arrangements is not deemed a departure from the spirit of the invention being limited solely by the scope of the attached claims.

What is claimed is:

1. A portable plant container comprising:
a base portion;
a cover portion attached to the base portion and at least partially removeable from the base portion;
a root chamber removeably secured adjacent the base portion;
a culture material contained in the root chamber;
a plant inserted at least partially in the culture material;
a growth chamber formed between the root chamber and the cover portion; and
means for attaching the base portion to a user.

2. The portable plant container of claim 1, wherein the means for attaching the base portion to a user comprises at least one band to attach the base portion to the user.

3. The portable plant container of claim 1, wherein the cover portion is made of a transparent material.

4. The portable plant container of claim 3, wherein the root chamber is made of a transparent material.

5. The portable plant container of claim 1, wherein the root chamber comprises a culture material access door which is selectively positionable to open and close the root chamber.

6. The portable plant container of claim 5, wherein the cover is selectively positionable to an opened position providing access to at least the growth chamber of the container.

7. The portable plant container of claim 1, wherein the culture material is transparent.

8. The portable plant container of claim 2, wherein the cover, the base, and the band are substantially made of plastic materials.

9. The portable plant container of claim 3, wherein the root chamber is made of plastic.

10. The portable plant container of claim 3, wherein the root chamber is made of biodegradable plastic.

11. The portable plant container of claim 1, wherein the cover comprises an integral magnifying lens.

12. The portable plant container of claim 3, wherein the root chamber is attached to a transparent plastic growth chamber.

13. The portable plant container of claim 3, wherein the root chamber comprises an aperture through a wall of the root chamber such that aerial portions of the plant may grow from the culture material into a growth chamber adjacent the root chamber.

14. A portable plant container comprising:
a cover portion;
a root chamber containing at least a portion of a plant and a culture material;
a growth chamber formed between root chamber and the cover; and
at least one band for attaching the cover portion to a user.

15. The portable plant container of claim 14 further comprising a base portion, wherein the cover is attached to the base portion and the cover is at least partially removable from the base.

16. A method for growing a plant comprising the steps of:
a) providing a portable plant container comprising a base portion, a cover portion, and a band for attaching the base portion to a user;
b) inserting a plant and a culture material into a root chamber;
c) attaching the root chamber to the base portion;
c) attaching the portable plant container to a user;
d) observing the plant grow over a period of time.

17. The method of claim 16, further comprising the steps of removing the root chamber and the plant from the portable plant container and transplanting the plant in the soil of a stationary growth area.

18. The method of claim 17, wherein the step of transplanting is accomplished by directly planting the root chamber into the soil.

19. The method of claim 18, further comprising the steps of allowing the root chamber to biodegrade to allow the plant to grow in the soil.

20. The method of claim 18, further comprising the steps of removing the roots of the plant from the root chamber and directly planting the roots and into the soil.
